(19) United States
(12) Patent Application Publication
(10) Pub. No.: US 2008/0197972 A1
(43) Pub. Date: Aug. 21, 2008

(54) Traceability And Authentication Of Security Papers

(75) Inventors: Marcus Maxwell Lawson, Hampshire (GB); Francis Kirkman Fox, Hampshire (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: MAGNA AUTOMOTIVE SERVICES GMBH, SAILAUF (DE)

(21) Appl. No.: 11/817,080

(22) PCT Filed: Mar. 6, 2006
(86) PCT No.: PCT/GB06/00785

§ 371 Date: Nov. 27, 2007

(30) Foreign Application Priority Data
Mar. 4, 2005 (GB) 0504573.7

(51) Int. Cl. G07D 7/00

(52) U.S. Cl. 340/5.86

(57) ABSTRACT

A security paper such as a bank note has a data matrix printed or attached to it. The data matrix includes an encoded unique identifier for the security paper which may be read by a scanner and compared with a store of unique identifiers to authenticate the bank note. The remote store may include an indication as to whether or not the bank note is activated or whether it has not been issued or has been released from circulation. Data on the data matrix may be arranged in layers with a second layer containing further data associated with the bank note. The data in one or more layers may be encrypted using different encryption algorithms whereby different parties may have access to the data on different layers. RFID tags may be used in addition or as an alternative to data matrixes.

This invention relates to the production, authentication and traceability of security papers such as bank notes. It is particularly concerned with increasing the security of security papers such as, for example, bank notes and protection of bank notes and other security papers against counterfeiting.

At present, bank notes include a number of measures to provide security and anti-counterfeiting protection. These vary with the country of origin of the bank note. Typically, a bank note includes an alphanumeric serial number which is visible to the user. This serial number incorporates a number of identifiers including the country of origin, a series number, the denomination of the note and possibly other identifiers. It may additionally include a check sum. The Euro, which has recently been adopted by many countries in the European Union, is an example of a high-security bank note which includes a number of additional printing and creation techniques to protect it from counterfeiting. These techniques include a range of hidden viewable graphical features which are not ordinarily viewable but can help identify a note as authentic. Some of the features are sophisticated, for example, scrambled indicia which uses images placed without other images and encoded so that they cannot be viewed without that visual decoder. Other features include foils, paper watermarks, digital watermarks, micro-sized text and special inks. The security features protecting Euro notes are classified according to the level at which they are to be checked against and are known as Security Features Classification: Public, Professional, Central Bank, and Forensic. The public classification includes feel, look and tilt. The feel is based on the unique feel of the paper and the relief of intaglio printing which gives a tactile feel. The look includes features such as a watermark, security thread, and a see-through register. Tilt includes hologram foil stripe and iridescent stripe, hologram foil patch, and colour shifting ink.

The other classifications cover other elements such as Ultra-violet properties, and Microtext. The forensic classification covers properties such as DNA of banknote paper and other production & manufacturing data and chemical analysis.

Some countries use barcodes on bank notes which may be visible or hidden. Florescent or ultraviolet techniques may be used to reveal barcodes. These barcodes are used for various purposes including sorting by banks and basic bank note recognition and identification.

Despite the range and sophistication of techniques used to protect bank notes from counterfeiting, we have appreciated that present security measures are far from perfect. In particular, we have appreciated that authentication can be time consuming and difficult and requires the bank note to be in the hands of a trusted party before it can be fully authenticated. This makes is difficult for a bank note to be authenticated at a local outlet for example, in a retail shop.

WO 92/05521 of De Nederlandsche Bank N.V. discloses the idea of placing a barcode on a bank note. The code represented by the bank note may also be printed on the bank note in a human readable alphanumeric form. A similar approach is taken in FR 2,832,239 (Pitoux).

GB 2406690 of Neopost Industrie SA, published after the priority date of this application, discloses the use of a data matrix as a data carrier for authentication data in a coupon, ticket or similar printed item.

U.S. Pat. No. 6,547,151 of ST Microelectronics S.r.l. discloses the use of an RFID tag placed on a bank note for authentication purposes. The tag can carry security information and, therefore, function in a similar manner to existing printed security codes on bank notes. Information may be password protected and may be added at different stages.

The present invention aims to address the deficiencies in existing bank note security and anti-counterfeiting measures and to provide an improvement on the prior art security and authentication systems and methods mentioned above.

According to the invention there is provided a system for authentication of security papers comprising a repository of security paper related data, the store including, for each of a plurality of security papers, a token including a unique identifier of a security paper, and a status indicator indicating the status of the security paper; a generator for generating for a security paper a data carrier having encoded therein a token including a unique identifier from the store; a scanner for scanning the encoded data carrier to retrieve the unique identifier from the token; and an authenticator for comparing the unique identifier with stored identifiers and the status indicator corresponding to that unique identifier for authentication of the security paper, wherein the token comprises a header, a payload and a security portion, the payload comprising encrypted data relating to the security paper or a reference to a remote location at which that data is stored.

Preferably, the unique identifier is carried in the header portion of the token. The reference to a remote location carried in the payload may be encrypted. In one preferred embodiment, the data carrier is graphic symbol such as a data matrix. In another preferred embodiment, the data carrier is an RFID tag.

Preferably, the authenticator is part of an authentication network comprising a plurality of authenticators, and the repository and the authenticators are linked. Preferably, at least one of the plurality of authenticators includes means for identifying an individual presenting a security paper for scanning, the system further comprising means for linking the record of the security paper stored at the repository to the individual.

The invention also resides in a security paper having a data carrier stored thereon, the data carrier having encoded thereon a token for authentication of the security paper using the system according to the invention.

Embodiments of the invention will now be described, with reference to the accompanying drawings, in which:

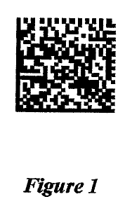

FIG. 1 is a view of a data matrix;

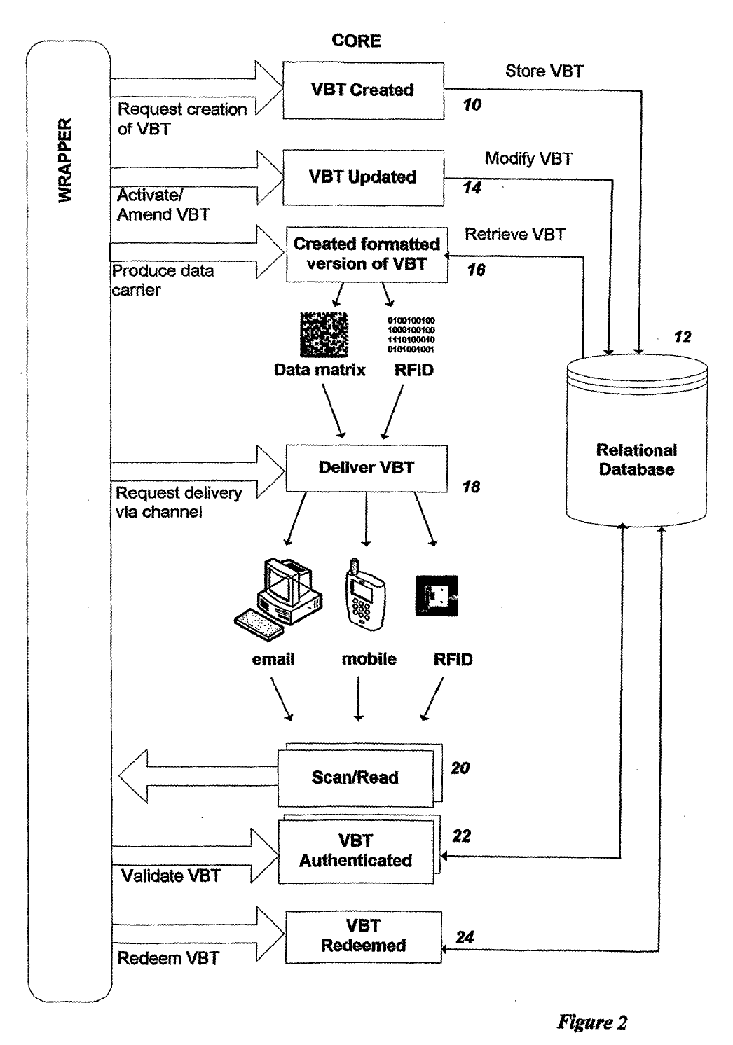

FIG. 2 is a schematic diagram of the core and wrapper of a system embodying the present invention;

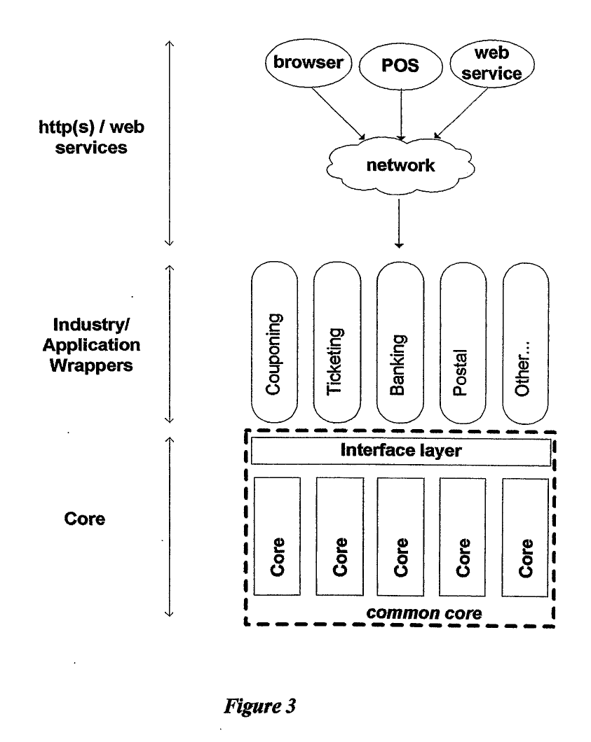

FIG. 3 shows how the core of FIG. 2 may be used with a plurality of different application Wrappers;

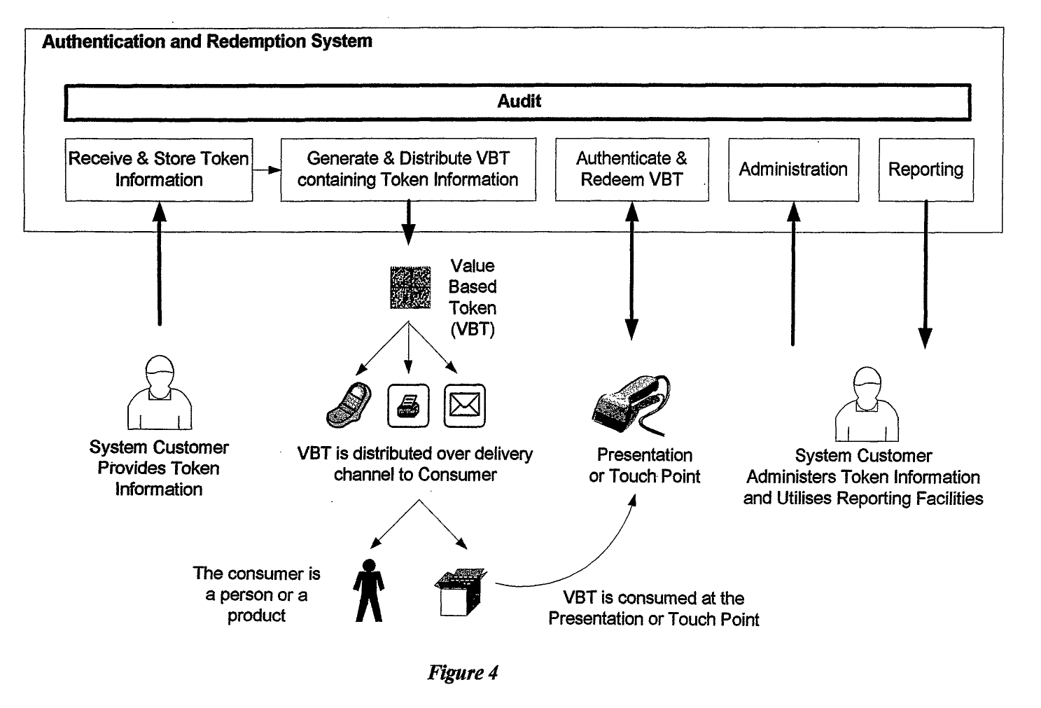

FIG. 4 is a schematic representation of the functionality of the system;

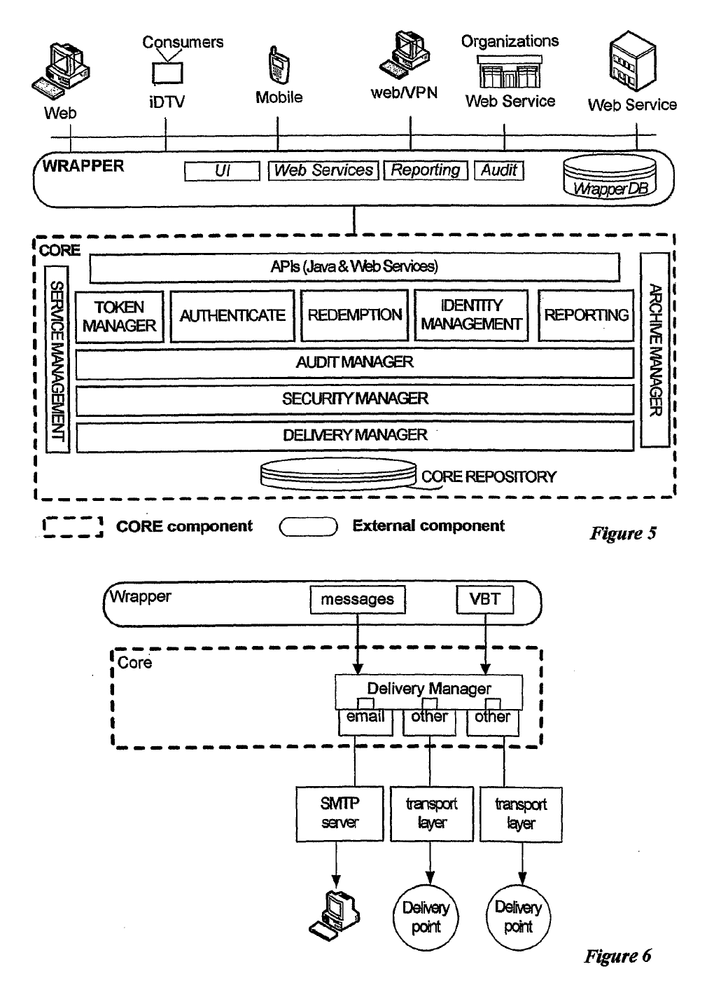

FIG. 5 is a representation of the software components of the core of the system of FIG. 2 providing the functionality of FIG. 4;

FIG. 6 is a representation of the functionality of the delivery manager of FIG. 5;

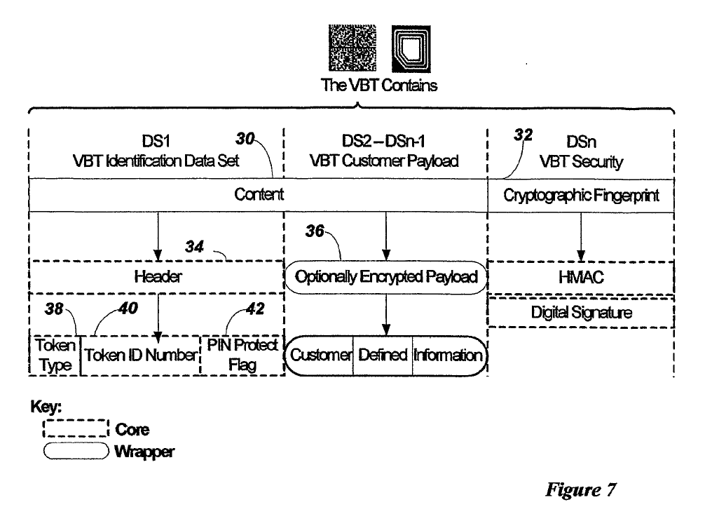

FIG. 7 shows the structure of a value based token embodying the invention;

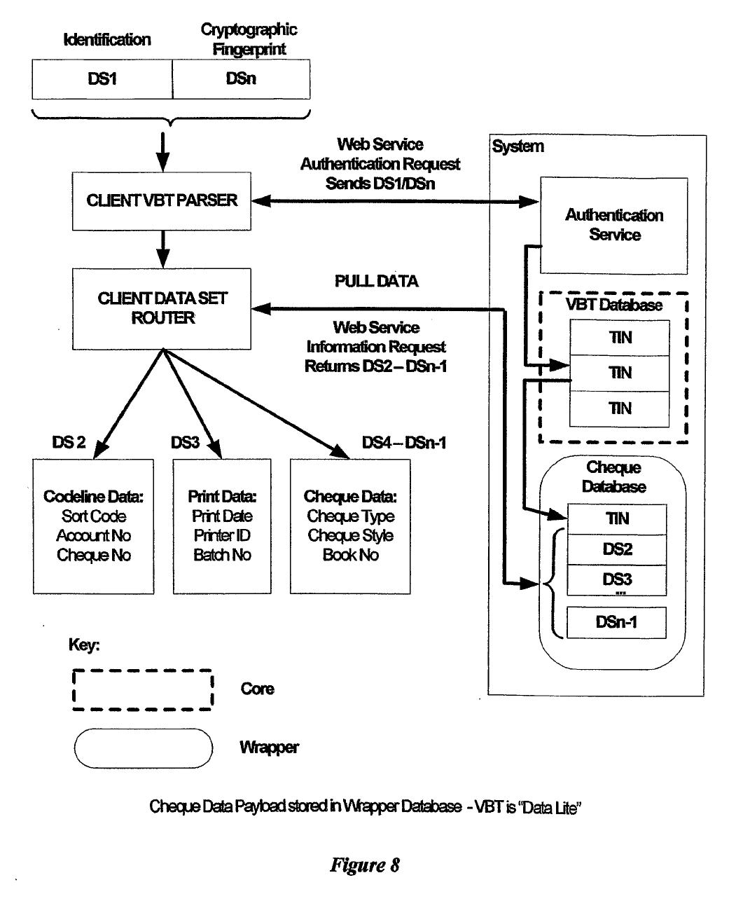

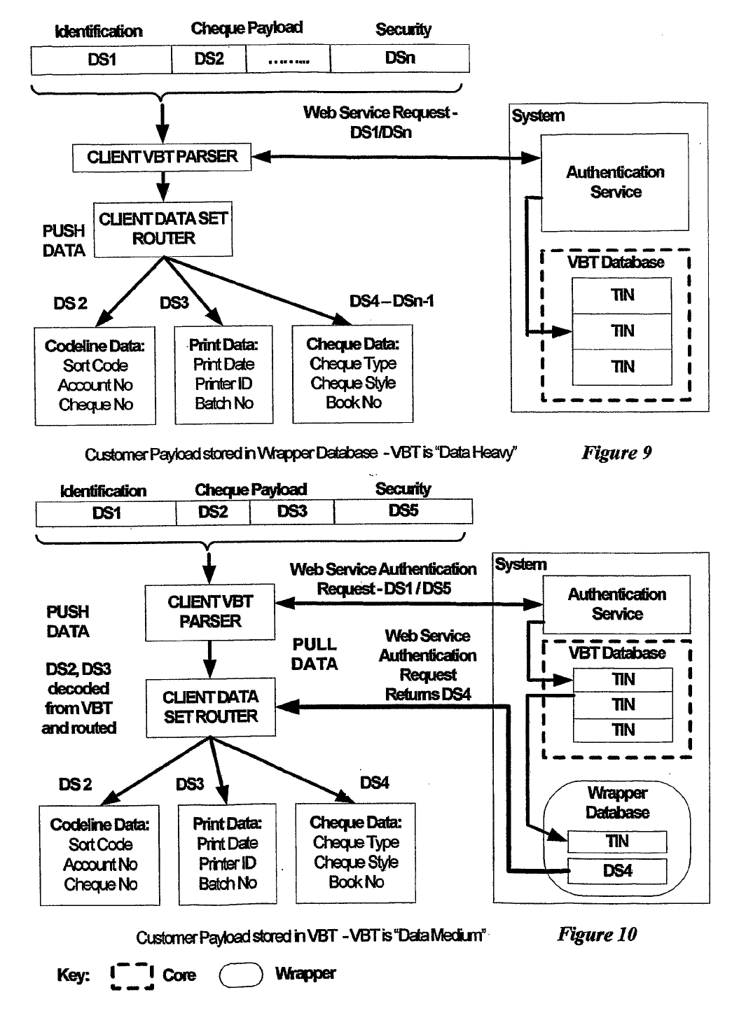

FIGS. 8 and 9 show, respectively, embodiments using data lite and data heavy value based tokens;

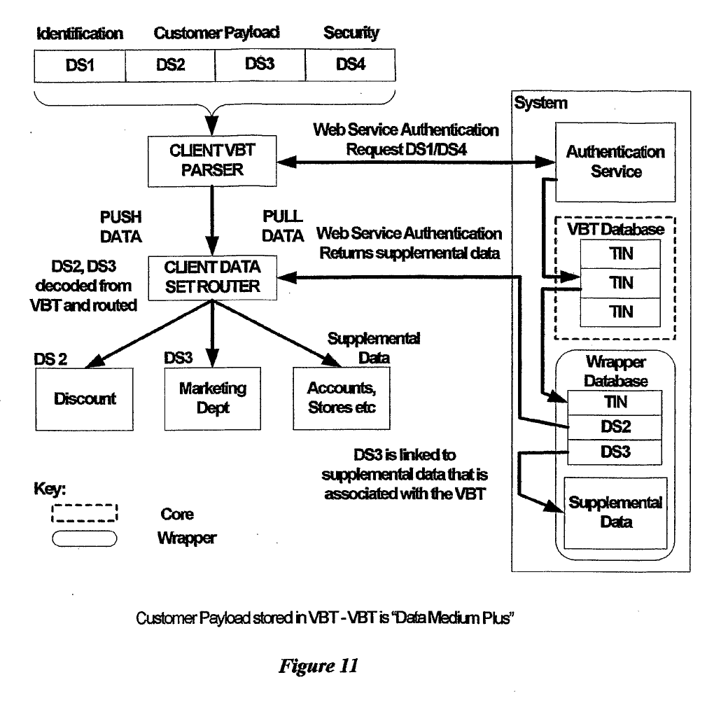

FIGS. 10 and 11, respectively, show VBTs having intermediate amounts of data in the token;

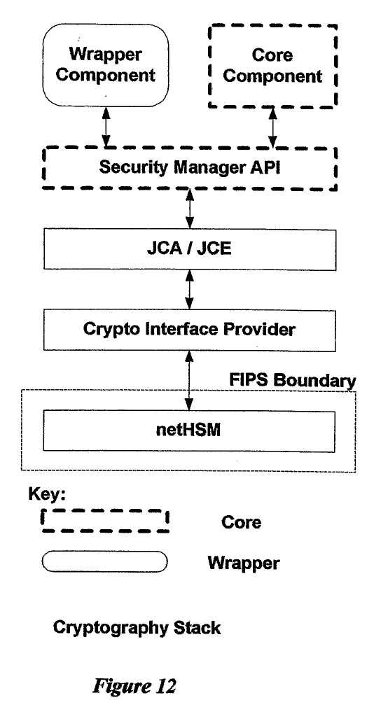

FIG. 12 is a schematic diagram showing cryptographic functions; and

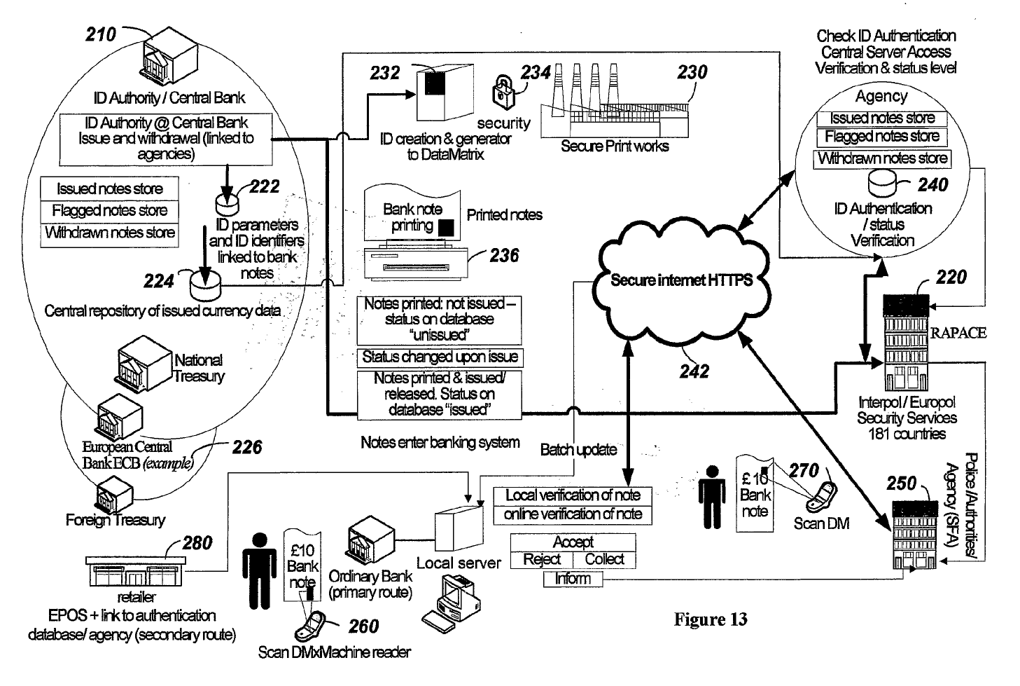

FIG. 13; is a schematic diagram showing the application of the system of FIGS. 1 to 12 to the authentication of banknotes and other security papers.

The system to be described provides a secure, web service based, authentication system for printed and other media types using data carriers such as Data Matrices and RFID. The system has a core generic part, which includes components that support generic functional requirements. The core components are extended on an application by application, or customer-by-customer to support specific industry requirements. These specific extensions are referred to as “wrappers”. The system is not limited to the Internet or World Wide Web but may be implemented on any type of network, for example a company private network. In many applications, embodiments of the invention will interface with existing networks of a user or set of users.

The system to be described may be used in a variety of different applications although the present application is concerned with the application to security papers, of which bank notes is a specific example.

The concept of a value-based token (VBT) is fundamental to the design of the solution and is discussed here briefly. A fuller description is given below. A VBT is a mechanism that allows a unique entity to be created, printed (or delivered via another channel) and subsequently authenticated. All VBTs have a unique identity, the ability to store data and security features to prevent their content and structure being amended maliciously. For example, a VBT generated for a money-off coupon may contain a unique token number, details about the product the coupon can be used against and a message authentication code (MAC) used to identify if a token has been altered.

The preferred data carrier for the VBT is the Data Matrix (DMx). However, other data carriers may be used depending on the nature of the VBT and the data to be carried, and the geographical region in which the solution is to be implemented. The nature of the data carrier is described in detail below. Data Matrix is an encoding standard used to produce a 2-D barcode such as the one show in FIG. 1. In essence the data matrix is the transport mechanism for the VBT. It can be included in a document, on some other form of printed media or could even be applied to a product itself. At some point in the VBTs life it will be read (scanned) and then authenticated and/or redeemed by the system.

A Data Matrix encodes information digitally in the form of a checkerboard pattern of on/off. Data Matrix is defined by ISO standard, ISO/IEC16022—International Symbology Specification, Data Matrix.

It is possible, in some embodiments of the invention, that the VBT will never be printed, for example if it remains in electronic form. In such a case, the VBT may not need to be encoded on a data carrier.

FIG. 2 provides an overview of the interaction between a wrapper (industry implementation) and the core. The core includes a database, for example an Oracle 10 g database which holds data to be included in the VBT and data which is related to data held in the VBT, as discussed below. The core is responsible for creation, updating and delivery of VBTs as well as the creation of formatted versions of VBT for inclusion on the selected data carrier. The core is also responsible for the processing of scanned data carriers to authenticate them and to update the database to show that a given VBT has been redeemed. The wrapper holds information that is specific to an application so that, for example, where the data carrier is applied to a coupon, the wrapper will hold information that is specific to that application, such as the data structure of the VBT, the type of encryption used and the data carrier into which the VBT is to be formatted. This approach makes is simple to adapt the system to new applications for the VBT.

The various functions of the core shown in FIG. 2 will now be described in more detail.

Creation 10: During token creation, the core creates a unique identity for the VBT and stores it in the token repository (database 12). A VBT will carry data relevant to its application although it is not a data store in itself. For example, a VBT used to secure a cheque may contain the payee, account and amount. The wrapper is responsible for passing all application specific data to the core. Each type of VBT will have specific security requirements defined in a security policy. For example, a simple voucher may only need a message authentication code to prevent data being changed whereas a bank cheque may require encryption and a digital signature. The core will apply these security features automatically during creation. The structure of the VBT is discussed below.

Update 14: A wrapper may need to update a token during its life, usually to change its status. The core allows updates providing they do not violate the rules defined for the token type, e.g. a wrapper can change the token status from ‘created’ to ‘active’.

Format for data carrier 16: A wrapper can request that a VBT is built for a particular data carrier, for example a Data Matrix or RFID. The core chooses the appropriate software application for the data carrier and uses it to construct a VBT of this type. New providers can be plugged in to the core and configured for use via an administration interface.

Deliver 18: The core allows a wrapper to send tokens via supported channels. Messages sent via the core can use generic XSLT templates to format messages. Alternatively, a wrapper can construct a message itself and simply send it via the core. Messages may be delivered via email. Additional channels may require access to third party messaging gateways for example, to send SMS messages.

Read VBT 20: A VBT will be scanned/read at the point of use, for example a bank or a retail outlet. The content of the VBT can be used locally if required. However, to authenticate or redeem the VBT the content will be securely sent via the wrapper, e.g. a web service call. The wrapper can apply custom validation, business logic before using the core to authenticate and/or redeem the VBT.

Authenticate 22: The wrapper will pass the entire content of the VBT to the core for authentication. During this process the VBTs security features are used to validate its authenticity, i.e. PIN, MAC and signature. Where a VBT contains encrypted data the core will unencrypt and return the clear text to the wrapper where additional processing can be performed.

Redeem 24: The wrapper will pass the entire content of the VBT to the core for redemption. The VBT will be checked by the core to ensure it is valid and if successful will update the VBT to a redeemed status. VBTs will normally be redeemed only once; however the core will allow tokens to be configured to allow multi-redemption of a single VBT. This may be required in some applications, where, for example, the VBT relates to a multiple entrance pass for a venue.

A typical deployment will include the core extended with a wrapper, which is a customisation for a specific application). FIG. 3 shows several deployments, each with their own wrapper. The wrapper may extend the core to implement additional data requirements, additional validation/business logic, customize the look & feel and provide a user web portal. In FIG. 3 examples of wrappers for couponing, ticketing, banking and postal applications are shown.

FIG. 4 shows the outline functionality of the system. There are five basic modules which are described in detail in relation to FIG. 5 below: Audit, Receive and Store Token Information; Generate and Distribute Value-based-token (VBT) containing Token Information; Authenticate and Redeem VBT; Administration; and Reporting. The receive and store token information module receives token information from customers who provide details of the data that is to be included in the token. For example if the token represented a money-off token, the identity of the token as a money-off coupon, and the token value, the product to which it relates and other parameters are supplied by the customer via a wrapper for that token type, as is described below. The generate and distribute module takes the token information and forms it into a value-based-token having a structure described below and then encodes the VBT onto a data carrier. The data carrier is then distributed to consumers over any convenient delivery channel such as, but not limited to, the postal services, email, fax, commercial print works and web based distribution. The consumer is a person or even a product. The VBT may be applied to a coupon or the like that a person can redeem or may be applied to a product such a labelling or packaging. The authenticate and redeem module is responsible for verification of the authenticity of a VBT bearing data carrier when it is presented. The data carrier will be scanned and the encoded VBT recovered and verified by the system in a manner to be described. Finally the administration and reporting modules allow customers to interact with the system to provide them with selected information about the generation, authentication, and redemption of tokens by the system in accordance with their level of permissions.

FIG. 5 illustrates the software components that comprise the core. The core supports Internet and Intranet access via a browser which is also used to access the core administration interface and web service calls to APIs. Components are built using a J2EE development framework.

The following processes form part of the core solution. Each wrapper may use all or a subset of these processes to deliver the most appropriate solution
User Account Creation
User Account Maintenance
Login/Logout and Session Management
Key management
Token Creation
Token Maintenance
Token Generation (format VBT for data carrier, e.g. data matrix)
Token Encryption
Multi-channel Token Delivery
Token Authentication
Token Redemption
Multiple Token Redemption
Token Batch Creation and Management
Unique Token ID generation
Token History Reporting
Audit Reporting

### Token Manager

The Token Manager component supports the creation and maintenance of VBTs within the core repository. It does not include any authentication or redemption functionality to provide additional security and deployment options. The token manager provides for creation of a unique entry in the core repository representing a VBT; maintenance of a history of all token events, e.g. creation, update etc. The token manager can specify an optional free text payload that will be contained within in the generated token. For example, this payload would be written to a data matrix or written to an RFID chip. This payload is referred to as the embedded payload.

The token manager can also specify an optional free text payload that is stored in the database. This payload is referred to as the additional payload. This payload will not be included when the token is generated. Additional payloads can be retrieved when a token is authenticated or redeemed. The token manager controls updating of a token's additional payload. A token can only have one additional and one embedded payload. A token's embedded payload cannot be updated unless it is in created status. If it has any another status it may already have been delivered, e.g. printed, and the delivered content cannot be amended. The token manager can specify an optional pin/password to secure a token. It is also responsible for activation and cancellation of tokens. Prior to activation any attempt to authenticate or redeem a token will fail. A token is only valid between its start and end dates. These dates include a time element. The token manager can create tokens for different data carriers.

A token's security features, such as whether it contains a digital signature, are defined in a security policy. The following combinations of token, wrapper (payload) and security data may be supported:
Token
Token+Payload
Token+Payload+MAC
Token+Payload+Digital Signature

The payload can be clear text or encrypted depending on the application. Every token event (creation, update etc) can be audited and a token batch can be created and used as a logical grouping of tokens. A batch includes a meaningful name. A token may be assigned to an existing batch.

The core supports an extensible token lifecycle so that new statuses and the valid transitions between statuses can be defined. The token manager can also redeliver an existing token, for example, if the original has been lost.

The operation of the token manager will be better understood from the following use cases.
Use Case Name: Create Token
Actor/Role: Wrapper
Description: Create VBT entries within the repository
Pre-Conditions Wrapper is authenticated and authorised to use the service. Where a batch is specified the batch must already be created.

### Flow:

1. Wrapper sends token details to the Token Manager component. As a minimum the token type is required. Other optional attributes include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. Validate that the token type is available for the current service.
3. Validate token details. The PIN preferably has an alphanumeric value up to 30 characters in length. If an additional payload has been specified, i.e. it will be held in the database, the token type must be validated to confirm this type of payload is supported. If a status other than ‘created’ has been specified it must be a valid transition from ‘created. The batch must exist.
4. Generate token identification number [TIN]. This will be generated via the Security Manager that provides random number generation. The TIN may, for example be of fixed length such as 16 digit numbers for the TIN. However it is preferred that the TIN length is configurable as this further increase the flexibility of the system. The TIN (Token Identification Number) need not necessarily be just represented as a series of numbers and may be formed using any number base, for example Hexadecimal. The representation is chosen to enable the most size efficient encoding method for a particular data carrier such as a Data Matrix.
5. Generate token key. This value is also generated using the Security Manager's random number generator. This is a unique internal key for the token which will be used when referencing the token externally, e.g. from an email. As the key is not embedded within the token it is more difficult for malicious users to obtain.
6. Retrieve the security profile for this service/token. This will determine how the token should be constructed. The security profile will include:

| | |
|---|---|
| Hash | Hash/HMAC function used for MAC |
| Signature | Cipher used for digital signature |
| Encryption | Cipher used for encryption |
| Method | Describes which security features to use. |

7. Apply security policy to generate VBT string. If required, calculate the message digest of the token header and payload using the Security Manager. One suitable standard is HMAC-SHA256.

If required, calculate the digital signature of the token using the Security Manager. One suitable standard is RSA-SHA256.
8. Create token and its payload(s) within the repository.
9. Create a token history record containing all the token details.
10. Write an audit record of type ‘TOKEN_CREATION’ for the event.
11. Return the TIN to the wrapper
Use Case Name: Update Token
Actor/Role: Wrapper
Description: Amend VBT details (e.g. setting status to ‘active’)
Pre-Conditions: Wrapper is authenticated and authorised to use the service.

Where a batch is specified the batch must already be created.

### Flow:

1. Wrapper sends token details to the Token Manager component. In addition to the TIN the attributes may include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. In addition to the validation checks performed for these attributes in the ‘create token’ use-case the following checks should be performed. The embedded payload can only be updated if the token has a status of created. If a new status is specified it must be a valid and current transition as defined in the Token Management component.
3. Re-apply security policy to generate VBT string.
4. Update the token and payload (if amended) within the repository.
5. Create a token history entry in the repository.
6. Write an audit record of type ‘TOKEN_UPDATE’.
Use Case Name: Generate Token
Actor/Role: Wrapper
Description: Generate a VBT for specific data carrier (e.g. data matrix)
Pre-Conditions: Wrapper is authenticated and authorised to use the service

### Flow:

1. Wrapper sends request to the Token Manager. The TIN will be specified to identify the token. The wrapper may also use the attribute: Data Carrier. In a preferred embodiment, two data carriers are supported:
→ Text: Simply returns the raw VBT string.
→ Data Matrix: Encodes the VBT string using data matrix symbology.
2. Validate the TIN and Data Carrier.
3. Retrieve the provider (class responsible for encoding the VBT string) for the data carrier.
4. Encode the VBT string for the requested data carrier. For example, where the data carrier is data matrix a 2-D barcode will be generated using the data matrix image or font generator.
5. Return encoded VBT to the wrapper.
6. Write an audit record of type ‘TOKEN_GENERATE’.
Use Case Name: Create Batch
Actor/Role: Wrapper
Description: Create a batch (logical container for VBTs)
Pre-Conditions: Wrapper is authenticated and authorised to use the service.

### Flow:

1. Wrapper sends request to the Token Manager component. An optional batch description can be specified.
2. A batch is created with a unique identifier.
3. Return batch identifier to the wrapper.

### Token Manager API

The following Java API's Will be exposed to wrapper modules. The APIs are built to allow new commands to be added as required without altering any existing API calls.
createToken—Create a token as per the use-case described above.
updateToken—Update an existing token subject to the use-case describes above.
generateToken—Encode the token into a Data Matrix or other token formats such as RFID.
createBatch—Creates a new batch in the token repository and returns its ID to the calling module.

### Authenticate

The authentication component is responsible for authentication of tokens when they are read or scanned.

If a token has been signed the signature must be validated during authentication. An invalid signature will result in authentication failure. If a token contains a MAC this must be validated during authentication. An invalid MAC will result in authentication failure. During authentication a check is performed to confirm that the token exists within the repository. A missing token will result in authentication failure. During authentication the token's start and end date must be checked together with its status. When a status is defined it will be assigned a flag that identifies whether it will cause authentication to succeed or fail. For example, a status of ‘created’ may cause authentication to fail and a status of ‘active’ may result in success. If a token has been secured with a PIN, the PIN should be supplied and checked as part of the authentication process. If the supplied PIN does not match the original value the authentication process will fail.

On successful authentication or redemption the additional payload is returned (if requested).

All authentication requests successful or otherwise should be audited. The manner in which the authentication component operates will be understood better from the following use cases.
Use Case Name: Authenticate Token
Actor/Role: Wrapper/Web Service
Description: Verify Token Details
Pre-Conditions: Actor is authenticated and authorised to use the service.

### Flow:

1. Wrapper sends token content to the Authenticate component. It also specifies whether the additional content should be returned on successful authentication and any PIN details specified by the user.
2. Retrieve the security profile for this service/token type using the service management component. This must be the policy in place at the time the token was created.
3. If a PIN is required to use the token the PIN value supplied must be processed to ensure it matches the PIN digest stored in the repository.
4. If the security policy specifies a digital signature use the Security Manager to validate the signature. If the signature is invalid return an authentication failure status.
5. If the security policy specifies a hashing algorithm use the Security Manager to validate the message digest. If the message digest is invalid return an authentication failure status.
6. Confirm the token exists in the repository and that its status contains a valid ‘authenticate’ flag.
7. Validate the tokens start and end dates.
8. If a token's redemption count must be less than its redemption limit (the maximum number of times it can be redeemed).
9. If all the above steps have passed the validation process returns a valid status to the actor and the additional payload (if requested)
10. Write an audit record of type ‘TOKEN_AUTHENICATE’.

### Authentication API

The following Java APIs support the authentication use-case above. Although a default authentication Web Service is part of the core most wrappers extend the authentication process. In this case the Java APIs can be used to support the requirements of their redemption process.
authenticateToken—using the security features on the token, this API verifies that the token is genuine and has not been tampered with.
authenticatePIN—compare the PIN stored against a token with a user supplied value.

### Authentication Web Services

AuthenticateToken—this service supports the authentication process defined in the above use-case. If the service consumer requests the token's additional payload it is returned only on successful authentication.

### Redemption

This component is concerned with redeeming tokens after they have been authenticated.

Before redeeming a token it must pass all token authentication tests. A token can only be redeemed if it has a status is flagged as ‘redeemable’. For example, the token statuses ‘created’, pending’, ‘approved’ and ‘redeemed’ may be defined and tokens may only be redeemed in they have a status of ‘approved’. A token can be redeemed more than once, with the maximum number of times a token can be used being defined for a token at its creation. By default a token can only be redeemed once.

All attempts to redeem a token are written to an audit log, and when successfully redeemed a token's status is updated to ‘REDEEMED’ (or to a specific status).

The operation of the redemption component is further explained by the following use case.
Use Case Name: Redeem Token
Actor/Role Wrapper/Web Service
Description: Amend token details (e.g. setting status to ‘active’)
Pre-Conditions: Actor is authenticated and authorised to use the service

### Flow:

1. Actor sends token content to the redemption service including any PIN details specified by the user.
2. Token is fully authenticated as per the Authenticate Token use-case. If authentication fails a failure response is returned to the Actor.
3. Token status is updated to ‘redeemed’ (or to whatever status the actor has requested, subject to transition rules).
4. Increment the redemption count.
5. Write the transaction to the audit log.
6. Return the redeemed payload to the Actor.

### Redemption API

The following Java APIs support the redemption use-case above. These can be extended to support a custom redemption process.
redeemToken—Redeem the token as per the use-case defined above.

### Redemption Web Services

RedeemToken—this service supports the redemption process in the above use-case. On success the redeemed payload is returned.

### Identity Management

This component only manages basic account information. This includes a ‘display name’ that may be used for reporting purposes and default values for e-mail address and/or mobile that can be held as default values for the appropriate delivery channels. Users of the system authenticate themselves using a username/password. Calls to service based functions (web services) can authenticate via username/password or Certificate Based Authentication (x509.3). An administrator may register new users via a User Interface (UI)

### Identity Management API

The following Java APIs are exposed to the wrappers.
authenticateUser—authenticate a user's credentials and create a new session.
isSessionValid—returns true if the current session is still valid.
getSession—returns the current session which can be used to identify the user's account and other session details.
maintainAccount—create and maintain user account details.
hasRole—returns true if the current session has been assigned a particular role.

### Identity Management UI

The following user interfaces are provided for the identity management component.
Login—Basic login screen. Username/password authentication.
Error Page—A generic error page used to display authentication, page access and general error messages.
User Registration—This screen allows administrators to create accounts for new users and assign them an appropriate role.

### Reporting

The reporting component is responsible for the reporting functionality. Reports will be called from the administration screens and provide flexible reporting based on audit records written by the core components. Redemption reporting can report on both successful and unsuccessful redemption attempts. Successful redemption records include the date/time stamp, account, token type and optional location id if provided by the web service. Failed redemption attempts include date/time stamp, account, token type, optional location id if provided by the web service and information about the reason for the failure. Each token listed in the redemption report provides drill down functionality to get further information about the token. Reports can summarise the status of all tokens or a subset of the tokens as defined by parameters provided to the report. This report accepts dates, service and token type as parameters. A status summary report provides a drill down to get further information about the tokens in each status. A token report by status lists all the tokens in the given status that fall within the parameters passed to the summary report. It is possible to drill down on each token. The complete history of a token can be reported and a status summary report is available to report on the tokens associated with a batch.

The core reporting functionality does not include management information in the preferred embodiment. This is implemented on a wrapper-specific basis.

The reporting included as part of the core falls into the following categories:
Audit Reporting
Redemption Reporting
Token Reporting

The audit reporting provides parameterised reports on the application audit table. This report may be parameterised based on a date or date range, the service, the audit level or the audit type. Each of these parameters is optional.

The redemption report provides information about successful redemptions and those that have failed. The redemption report may be parameterised based on the service, a date or date range and the token type. The report provides detail about the account and a ‘location id’ if provided by the web service. The failure report also includes any error codes that will provide further information about the reason for failure.

The token report lists a summary by status of all tokens within the system. This report has optional parameters of service, token type and date or date range. The token report by status provides information about the date the token was updated to the selected status and the account that requested the update. Each token will link to a token history report.

The token history report provides information on each status transition that the token has made. It will also report on the accounts that requested the transition, the date and any additional details that may have been supplied e.g. delivery channel, error code or location id. This report will include both successful transitions and transitions that have failed.

It will be appreciated that the reporting functionality available is highly advantageous as it allow tracking of tokens by the token creator. This may, for example, be the issuer of a money-off coupon who wants to track how many coupons have been issued and redeemed.

Audit Manager

The audit manager component handles audit requests. The core allows custom audit types to be defined (for use in a wrapper). Audit requests include an audit level. This allows the audit component to be configured to only record events within an audit threshold. All events associated with a token are audited and written to a token history. It is also possible to add a cryptographic seal to audit records, e.g. a digital signature produced using HSM, to provide evidence if the content of the audit record is modified.

Within the core components there are two types of auditing: Core Application Auditing and Token Auditing. The core application auditing allows audit records to be written for a range of actions. The actions that are audited are controlled at a service level. Each piece of audit information is categorised according to the Audit Type e.g. Login, UpdateReferenceData. Each Audit Type has an associated audit level. The level of audit required is associated with the service within the application reference data. Before an audit statement is written a check is made to see whether the audit record to be written has an audit level less than or equal to that defined for the service. Any audit record with an audit level in the correct range will be written to the audit able.

Each Audit Record will include the following information:
A date/timestamp indicating when the record was written;
Information showing the type of audit record that is being written and the audit level assigned to that information;
The service that the audit record has been written for;
An optional message—to store non-standard details;
Information about the account that triggered the writing of the audit record—this will always populated unless the audit record is for something like a failed log in.

A separate table is populated to support the token auditing requirements within the core application. Each time a token is created or a change is made to an existing table. A record is written to a table that records information about changes made to the tokens. This provides a complete history of the token life cycle for each individual token.

Each Token History Record includes the following information:
The id associated with the token that has been created or updated;
The account that created or updated the token;
A date/timestamp indicating when the record was written;
A short description from a list of allowable values that will describe why the record was written;
A flag indicating whether the record has been written after a successful update or a failure;
Any error codes returned by the application will also be included in the token history record if the creation/update of the token was a failure;
If an activate call is made the delivery method and detail values are populated to record the route via which the token was delivered;
If the validity dates of the token are changed the new dates will be recorded in the history record.

If an authentication or redemption web service call is received that includes information about the location where the web service has been called from e.g. a till id/store id/merchant id this is stored in the history record.

### Audit Manager API

writeAudit—create an application audit record.

The core and wrappers can create data that is auditable to the highest standards. This allows the system to provide non-repudiable data. This ability is integral to the reporting linked to unique identities represented by the TINs and their authentication path. It means that value based transactions can be safely performed whether the value is monetary or otherwise. However with true audit level data sitting behind the normal reporting modules, linked to the client's wrapper behind it) “transactional monetary Properties” can be safely associated with it. Therefore when an authentication and redemption of a VBT representing a coupon, ticket, voucher note etc is done it can be linked to a real monetary transaction such as a micro payment or some other form of banking system like money transfer. This gives clients the ability to do financial reconciliation in real time if they require. The level of security and trust in the entire system allows a client to make real financial links and account in the true sense. Thus the presence of non-repudiable data is highly advantageous. One aspect of non-repudiation is time of creation. Reliance on system time is not sufficient as it can be manipulated. Embodiments of the present invention enable a non-repudiable time stamp to be applied to VBTs which can be relied on.

### Security Manager

This component handles security within the core and preferably uses the Public Key Infrastructure (PKI). PKI is a set of technologies, standards and procedures that define an enterprise-level security infrastructure. Components of PKI include:
Secret (symmetric) keys
Public and Private Keys (asymmetric keys or KeyPairs)
Digital Signatures, which use Hashing algorithms and Message Digests

All cryptographic functionality may be implemented using the Java Cryptography Architecture (JCA) and Java Cryptography Extensions (JCE) APIs.

The security manager seals tokens with a MAC which can be validated by the core. A digital signature can be created for a token using a service's private key and can be validated by the core. The content of a token can be encrypted using a service's private key and the content can be decrypted. The core supports generation of true random numbers, e.g. to produce token Ids, and stores a token's credentials (PIN/password) securely, e.g. using cryptography to store a message digest generated from the credentials.

### Security Manager API

The following security commands will be provided via a java API. The API is built to allow new commands to be added as required without altering any existing API calls.
createMAC—creates a message authentication code using the key/algorithm defined for the service/token type.
validateMAC—validate a token's MAC using the key/algorithm defined for the service/token type.
encrypt—encrypt data using the key and cipher defined for the service/token type.
decrypt—encrypt data using the key and cipher defined for the service/token type.
createSignature—create a digital signature using the private key and cipher defined for the service/token
validateSignature—validate a token's signature.
createMessageDigest—create a message digest using a specified hashing function, e.g. to create a PIN hash.
generateTRN—generates a true random number.
applySecurity—apply a security policy to a VBT.

### Delivery Manager

The delivery manager enables messages (which may include a VBT) to be sent via different channels. The delivery manager is an extensible component allowing support for new channels to be developed and plugged in without modifying the interface between the wrappers and core and is shown in FIG. 6.

The core supports multi-channel delivery of VBTs which may, for example, include email delivery. A message template may be defined that will be used to deliver a token via a specific channel. Whenever a token is sent via the delivery service an audit record is written.

### Delivery Manager API

SendMessage—delivers a token via a specified channel using a template defined for the service/token type.

### Service Management

The token management component allows an administrator to create and maintain the reference data associated with a token. An administrator may create a service via a user interface (UI). The Service Management UI enables an administrator to assign supported token types to service, and to create and maintain service roles. The administrator can create and maintain token statuses and configure tokens to enable or disable the use of additional payloads. A token status indicates whether redemption is possible and also indicates whether a token would pass authentication in this state. An operator may update token details in a batch, i.e. the same change is applied to multiple tokens for example, activating all the tokens in a batch. The core can support an extensible token lifecycle, making it possible to define new statuses and the valid transitions between statuses.

As there are a number of tables that need to be populated in order to configure the core components, there is a requirement to provide administration functionality to support updates to these tables. Administration functions and screens are only required for tables where the account holders or administrative account holders need to be able to make updates. A range of administrative functions is required to manage accounts within the core components. These functions allow for the creation of accounts and account maintenance. Whether these provide “self service” functionality or “administrator-only” functionality is determined at a wrapper level by the implementation of appropriate account types.

These functions maintain the tables within the core component schema and also the basic information that will be held in the LDAP directory to support login functionality. All administrative changes that are made by application screens are audited using the appropriate audit types so that a full history of the changes made and the actioning accounts is maintained.

### Service Management UI

Administration Screens may provide for the following:
Service Configuration—this screen allows administrative users to update the audit_level, error_level and audit_method of the service. The service information screen also allows the security policy associated with the service to be updated.

Communication Templates—the screen allows templates (e.g. an email template) to be created and updated by users with the appropriate permissions. Service/Account Mapping—a screen and/or API is provided to add new accounts to the appropriate service. An account must also be assigned an account type for each service to define the level of access the account holder has. The administration screen also allows for updates to the account type.

Account Types—A screen is provided to create account types and associate them with the appropriate roles to define their usage of the core components. The screen also allows administrative users to maintain the roles associated with account types.

Audit Types—A screen is provided to maintain the audit types available within the system in case any of the audit levels need updating.

Service Delivery Options—A screen is provided to maintain the delivery options that are available on a service-by-service basis. This screen will enable administrative users to switch delivery options on and off for the appropriate service.

Token Statuses—this screen allows administrative users to create and maintain token statuses.

Token Status Transitions—this screen allows administrative users to define valid transitions between token statuses.

Security Policy—this screen allows administrative users to define and maintain token security policies. These policies define the security.

Update Token—Maintain existing token details, e.g. change status, end date etc. requirements used during token generation, e.g. should a digital signature be created, using which algorithm.

Reporting—menu access to the reporting homepage The database used in the core may be any suitable database such as an Oracle 10 g database.

The structure of the value based token (VBT) will now be described in more detail.

FIG. 7 shows the structure of the VBT. The token contains a contents portion 30 and a security portion 32. The contents portion 10 is divided into a header portion 34 and a payload portion 36. The header comprises a first data set DS1, and the payload contains a number of further data sets DS2-DSn-1. The security portion comprises a further data set DSn. Typically the header will contain a data set having at least three sub-data sets. The first 38 identifies the type of token. This is required in any open system in which the token could represent a number of different things such as an identifier for a medical prescription or an identifier for virtual money. The Token type data set identifies the nature of the token. The second data sub-set is a Token Identification Number (TIN) 40. The TIN is a unique number that identifies a particular token. The Third data sub-set is a PIN (Personal Identity Number) 42 and comprises a flag. Depending whether this flag is set on or off, the person presenting the token for redemption will be required to validate the token with their PIN number which will be compared with a number stored in the data set 42. The header section appears in all tokens whatever their application. It uniquely identifies a token and indicates whether the token is PIN protected. Thus the header content is:
header: <type><tin><pin flag>
Type: Identifies the type of VBT (5 digits)
Tin: Unique VBT Identifier (16 digits)
Pin flag: Flag indicating pin requirement (1 digit

Preferably, the header is not encrypted. This is important in an open system in which the token type must first be read before a decision can be made as to what token type it is and, therefore, how it should be processed. The header, therefore contains information about the token itself.

The payload will vary depending on the nature of the token and its application. It contains information, which is related to the use to Which the token is to be put. In order to reduce the data content, and thus to enable the VBT to be encoded in a relatively small data carrier such as a data matrix, the actual data need not be stored in the payload. Instead an identifier is stored which, when read, enables data associated with that identifier to be retrieved from a database. Thus, for example, the database at the core/wrapper or elsewhere may store the bank account number, cheque number and sort code number of a cheque, together forming a bank identity. The payload merely holds data, such as an address that is sufficient to retrieve this bank identity from the database. The payload may be encrypted but it will be appreciated that the system is inherently secure as the information stored in the payload is meaningless, even when decrypted, without access to the database.

The content of the payload is specific to a wrapper and may even be omitted in some applications. The payload may comprise a plurality of data sets. In the description of the core above, these may comprise one or more datasets that are an additional payload and may be a reference to data or relational structures that are stored elsewhere, for example in the core repository. Each data set may be intended for a different purpose, for example for a different party or service.

Thus, the content part of the Value Based Token comprises a header data set which contains data about the token itself which may be unencrypted and may be divided into a number of sub-data sets; and a payload data set which may be encrypted and which contains a reference to data relating to the subject of the token enabling that data to be retrieved.

If the token's security policy specifies that the payload is encrypted the cipher (encrypted text) will be stored in the payload. Due to the binary nature of encrypted data it will be base encoded before storing it in the VBT. One suitable encryption algorithm is the AES symmetric algorithm for encryption of payload content. Thus:

Payload content: <free text>|<cipher text>

The security mechanism 32 will vary according to the intended use of the token and the type of data carrier on which is encoded. The security mechanism is a cryptographic fingerprint and protects the payload and header from tampering and counterfeiting. For example, the security mechanism may comprise a SHA 256 Hash or an RSA Digital Signature. A Hash has the advantage of being small in size and fast, whereas a digital signature is larger and slower, but more secure. The appropriate security mechanism will depend on the use to which the token is being put and the degree of security required. For example, a token which represents a small discount on an item form a supermarket will require much lower security than a token that represents personal cash or a cheque.

Thus, the content and size of this section is determined by the security profile defined for the token type and the key strength used in security algorithms.

Security content: [<message digest>|<signature>]

Message Digest: If the security policy specifies a hashing algorithm, the message digest is produced by the hashing the <header> and <payload>.

Signature: Where a signature is specified in the security policy the <header> and <payload> sections will be hashed and the resulting message digest signed with the service's private key to generate a digital signature. Due to the binary nature of message digests and digital signatures values will be base encoded before storing in the VBT.

It follows from the foregoing discussion of the core and the wrapper that the core defines the structure of the VBT and that the core also preferably defines the header and the security portions. The wrapper for that application may define the payload contents, which are specific to each application. Thus the syntax and semantics of the header and security portions are defined in the core as well as the supported encryption algorithms for the customer payload. The complete VBT is stored in the core but the payload is defined and constructed in the wrapper. If the payload contains references to other data or relational structures, for example due to capacity constraints of the data carrier, these too will be defined in the wrapper.

FIGS. 8 and 9 show how different VBTs can be constructed, depending on the application and the data capacity of the data carrier. FIG. 8 shows a data heavy VBT and FIG. 9 a data light VBT. In FIG. 8, the payload contains 1 or more data sets which, when read, are routed through a local data set router 100 which communicates with the system server 102 to authenticate the token TIN and routes the payload data sets to different end points. In the example of FIG. 9, there are three data sets in the payload: DS2, DS3 and DS4. DS2 is routed to a local authentication points such as a till, DS3 is routed to a marketing department and DS4 is routed to some other end point. An individual data set may be routed to more than one point, and the data in the data sets may have a degree of overlap.

In the FIG. 9 case, the VBT is data lite and comprises a header and a security section only. The payload is stored at the core server and referenced by the TIN in the header. In an alternative, not shown, the payload could include a data set that is a reference to data or relational structures stored elsewhere.

FIGS. 10 and 11 show intermediated cases where the payload carries some actual data but also references data stored elsewhere. In FIG. 10, the payload includes data sets 2 and 3. A fourth data set is stored at the wrapper database are is pulled when the TIN is provided for authentication. In the FIG. 11 example, one or more of the data sets in the payload is linked to supplemental data, shown as stored at the wrapper database. Thus, the TIN references the data sets and the supplemental data. This again reduces the amount of data that needs to be carried in the VBT.

FIG. 13 shows the lifecycle of a VBT. A token may exist in a number of states: Created, suspended or redeemed. A change in status may occur through the activities of activation, cancellation or authentication.

The content of the VBT depends not only on the intended use of the token, but also on the nature of the data carrier that is going to be used to carry the VBT. Many types of data carrier are available. The data carrier is a portable data transport medium and, must be capable of storing identity data string components. A data carrier is usually a type of barcode or RFID device.

The data transport is constructed to have the generic format of the VBT:

| | | |
|---|---|---|
| Header | Payload | Security |

By using a common VBT for all applications, the common format and approach can be adopted even though different markets and applications have different requirements on how to place ‘identity’ data (or portable credential) onto an item and what that data item must include. For example, the level of security used may vary from minimal to very high. This has an implication on the amount of data that must be held in the data carrier and, in turn, what data carrier is appropriate. At one extreme, the VBT may have just a header and a security portion having low security. At another extreme, the VBT may include high security and a payload having several data sets each including a large amount of data. In between these extremes, the payload may have one or more data sets one or more of which may comprise a reference to data stored elsewhere.

Existing 1D barcodes (for example EAN 13 and EAN128) and 2D symbologies need may be used. Examples are QR code and Maxi code, and the Data Matrix (DMx). PDF 417 barcodes, RSS (Reduced space symbology) codes and RSS Composite (1D plus 2D) may also be suitable.

Embodiments of the invention may be used in environments in which a chosen Data Carrier is already used, whether it is a printed or marked barcode or a RFID type carrier. This pre-existing barcode type may be required for the solution as already have printing devices and scanning technology. In some cases, the VBT may be added to existing data carriers, such as a carrier used by a customer for other purposes. This is particularly possible on RFID devices which have a relatively large storage capacity but may also be possible on other carriers.

It is possible to create hybrid data from the actions and status of a client or consumer, for example by updating information and/or the data sets to create a new VBT either on the existing or a new data carrier. How the new hybrid VBT is sent to the data carrier depends on the Wrapper but follows the same route for its predecessor but may occur at a different place. In a particular solution user Rules may be require the first carrier to be scanned again before the second is scanned providing a two part verification process building a authentication picture. This is desirable, for example, in a ticketing situation. For a coupon the new VBT may be an update of where a customer had used the coupon and what status had changed, ready for the coupon to be used again. In this context a receipt printed at a till could easily print out a new carrier.

Table 1 below shows a number of examples of data carriers that may be suitable for use with embodiments of the present invention, depending on the requirements of the application.

TABLE 1

1D Barcode type
(traditional range) eg EAN
13 or 128
Data Matrix (ISO/IEC
standard 16022)
QR Code (ISO standard
18004)
PDF 417 (ISO standard
15438 - June 2001)
Maxi Code -
Vericode
RFID - all types (including
Gen 2) also known as
Radio Barcodes)
CHIP -
Magnetic data strip

Thus, the VBT is first created and holds the final identity output created in the system core before it is encoded onto the data carrier of choice. The VBT has header, payload and security components as specified in the wrapper that is specific to that application. Encoding the data into/onto a Data Carrier will not alter the information of the original VBT data string. Therefore in the example of the DMx it would turn the VBT into a DMx image which when scanned would translate back into the original VBT content. In an example of RFID the VBT would be onto the RFID tag.

It is preferred to optimise all data to suit the data carrier type. This may involve using specific character sets or Base encoding to reduce unnecessary content overhead such as encountered when creating a DMx. Some data carriers have specific input formats.

In some applications, the data carrier will be held by a third party. An example is a manufacturing company who have their own data carrier (DC) generating software. A DC output can be an image or more common to a font generator so is treated like text. The font must be installed on the processing machine to see or print the image. The VBT may be sent out raw from the system for encoding by the customer.

When the system described serves a Data Carrier output, for example a DMx, it needs to suit the client's requirements. If a client has different delivery channels: mobile, print via web, print to print company, print to marking technology etc. then the solution must be able to serve the optimal output for that channel. This is relevant to all 1D barcode and 2D symbologies where if an output is to an image format rather than a “font” then the physical size, dpi or pixel size has to be considered and matched to the requirement. In an example where a consumer could choose from a range of options to collect his coupon such as phone, home print etc, kiosk the system is able to create specific graphic outputs.

In one embodiment of the invention, more than one type of carrier output may be provided. For example, an RFID tag may be used with a traditional printed barcode. In that case, the system may supply two identities: the DMx and RFID information. These identities may be the same but allow for different scanning routes. In one embodiment of the invention, where a single DMx, or other chosen data carrier, is not able to contain all the data or where 2 identities need to be issued to a single item (containing different information or for different uses), then two or more data carriers may be issued.

FIGS. 8 to 11 also show how a data carrier with an encoded VBT may be read. The data carrier is first scanned to recover the VBT. The header in the VBT is not encrypted and from this the scanner, shown as the VBT Parser can determine the nature of the VBT. For example, it may identify the VBT as a coupon, a cheque, a ticket etc. This may affect the way in which the recovered VBT is processed. In FIG. 8 the VBT is constructed as data lite, which means that there is no payload. The TIN in the header is used to authenticate the wrapper and is used to access data sets that are stored elsewhere. In FIG. 9, the VBT is data heavy and the datasets are in the VBT payload. Thus, in FIG. 8, the VBT is recovered by the VBT parser, which sends an authentication request including the header and cryptographic fingerprint data sets to the authentication service. The TIN is recovered and compared with the TINs stored in the core repository, and if there is a match and authentication confirmation is sent to the parser as described above. In addition, data that is associated with the TIN, which is shown stored in a wrapper repository, but which could be elsewhere. This data comprises one or more data sets and may comprise data that is in the payload in the data heavy example. These data sets are pulled by a data set router and distributed to on of a number of recipients. As shown in FIG. 8, different recipients may receive different data sets although it is possible for each recipient to receive any or all of the data sets. In the FIG. 9 case, the data sets stored in the wrapper database in FIG. 8 are already part of the VBT and are pushed by the client data set router to their intended destinations.

The data-lite model for the VBT shown in FIG. 8 enables discretionary (DAC) and mandatory access controls (MAC) to be placed on the content referenced by the TIN in the core database. Discretionary access controls are generally granted by a person such as the object owner and determine read and write access privileges to the object to users and groups of users. Mandatory access controls are enforced by the operating system or database and protect classified data that has been protectively marked or labelled from being inappropriately accessed or disseminated to those with insufficient security clearance. This is a multi-level secure (MLS) implementation of core suitable for Government applications such as a National Identity card scheme.

For a VBT that represents the identity of a person in the form of a serial number, this scheme can be used to control the type of information that is returned about that person. In order to implement this level of control the core database needs to know who is making the request; what role the person is fulfilling; and the location from where the request is being made. This identity based information can be obtained from an X509 certificate identifying the client making the information request. The client is a trusted node in the network with a pre-defined security clearance.

The manner in which a data carrier may be presented to a user may vary according to the application. For example, where the VBT represents a coupon for redemption in a supermarket or other store, the user will access the website of the supermarket or a particular supplier or manufacturer and be able to download the coupon. This will involve a VBT being generated and encoded onto the data carrier as described above. The user can then print the coupon including the data carrier a present it for redemption at the supermarket checkout. Alternatively, the coupon need never be printed but may remain in electronic form for redemption against electronic purchases.

Thus embodiments of the invention use a value based token which is encoded onto a data carrier. The VBT comprises a clear header, a payload, which may be encrypted, and a security section. The header is a data set which allows the VBT to be identified and may comprise a number of sub-data sets. The payload is a further data set, which contains information, which allows a reader access to data. The payload could be split provided that the reader is able to distinguish between two different data sets. As the payload does not contain actual information about the token, but a pointer to where that information is stored, the security of the token is improved. Moreover, the token is far more flexible that prior art examples which are limited by the ability of the data carrier, such as a data matrix or bar code to carry information. As the information about the token is not actually held in the payload, this problem is avoided.

The VBTs are generated, stored, authenticated and redeemed by a system, which comprises the core and one or more application specific wrappers. This approach provides a system, which can generate tokens for a wide range of applications with all common operations being performed by the core and application specific operations performed by the application wrapper. Thus, different data carriers may be used, or different payload structures used without affecting core operations. This is highly advantageous.

FIG. 12 shows how cryptographic functions are handled. All cryptographic functionality may be implemented using the Java Cryptography Architecture (JCA) and Java Cryptography Extensions (JCE) APIs. The cryptographic functionality within the core may use nCipher's netHSM Hardware Security Module (HSM). The netHSM is a FIPS 140-2 Level 3 validated security boundary, i.e. a proven certified security boundary meeting cryptographic best practice. The HSM is accessed using nCipher's JCE provider implementation (nCipherKM JCA/JCE CSP) to perform encryption, decryption, key generation etc. Other JCA/JCE providers could be used.

FIG. 13 shows how the system described above may be used in a system which applies a data carrier bearing a VBT to a bank note, and how the bank note may then be tracked and authenticated at various points within its life, from creation to its withdrawal from circulation. Even after withdrawal, or destruction, the VBT record for a banknote may be retained to prevent fraud as is explained below. As discussed above, the VBT may be carried in a graphical symbol, or RFID tag on a bank note. The VBT and the chosen carrier enable data relating to the bank note to be stored which can be accessed and verified remotely and which can be checked, at various levels of security, locally by accessing records relating to that bank note held at a third party. The status of a bank note bearing the carrier may be dynamic and can be changed according to the nature of data stored remotely that relates to the bank note.

The following example is based on the carrier being a data matrix. The data matrix is printed on or otherwise incorporated into a bank note. The data matrix does not have to impact on the main design and its dimensions depends on the size of the VBT relating to the amount of information it holds and to the resolution at which it is printed. As will be discussed below, the data matrix may hold information in different layers of data which are accessible with parties with differing degrees of authority. The data matrix may be visible or may be hidden within an image. A micro-visible data matrix may be imprinted or laser etched on foil or some other medium in the bank note or printed onto the paper. It can be included as part of the printing process or attached in a non-removable manner. Hidden data matrices may use inks that are not visible to the naked eye such as infrared and florescent inks or magnetic inks to make the data matrix more difficult to copy. In this case Data matrices would be read by readers which respond to the inks used to form a data matrix. The data matrix is encoded with information regarding the bank note. Preferably, the data matrix holds some data in a secure encrypted form. This may be all the data held on the data matrix or some of that data. For example, the data may include a unique serial number. This may match the alpha-numeric serial number printed on the bank note. However, as will be explained below, incorporation of this number into a data matrix increases the security of the bank note as it makes validation of authenticity easier.

The data matrix may be generated as part of the bank note printing process. Typically, the printing of bank notes is performed by central banks, or by trusted third parties and performed at a secure print works. The data matrix is unique to each bank note and is produced by a data matrix identification generator. The identification created for each bank note may be passed to a central authority and stored in a central bank note identification database which can record the status of a given bank note. This enables the central authority to “turn on” or “turn off” bank notes. That is, the central database stores data representing whether or not the bank note is still valid and in circulation. The data matrix may be embossed, laser etched onto foil and may be micro size or full size. Any convenient method of application to the bank note is acceptable. It is envisaged that the data matrix will not have an impact on the main design of the bank note and may even be built into a picture on the note making each version of the image unique. The data matrix may be included after the main printing of the bank note or as part of the printing process.

The data matrix may store data in a plurality of layer. Each layer may have a different level of identification and may require a different degree of encryption and authentication to enable them to be read. For example, some layers may be visible to low level trusted parties whereas others may require a higher trusted status to read, or decrypt the data. As will be appreciated from the above description, each layer may be actual data held as payload data in the VBT using the data heavy or data medium models, or may comprise a reference to data stored at a remote database using the data medium or data lite model. The data at the database may be encrypted, using different encryption algorithms for different data levels and the references in the VBT payload may either be encrypted or in clear. Where encrypted references are used, the references for each level may be encrypted using different encryption algorithms. A combination of these techniques may be used, with some data being held in the VBT and some in the remote database. In all models, the VBT includes the token identifier TIN which may comprise one of the layers of data. The TIN may be unencrypted. This TIN is a serial number and could be the same as the alpha-numeric serial number printed on the bank note. A second layer contained in the payload or referenced by data in the payload may include information relating to the denomination of the bank note, the printing batch, security features included in the bank note, serial numbers, country of issue, identification of the printer, the date of issue and the issue number. These are only examples of possible data that may be held. Similarly, this further information need not be held in a single further layer but may be spread across several layers or portions of data each of which has different security and encryption used to limit that parties that can read the data on those layers.

The data to be stored on the data matrix can only be created by an issuing authority via the core and the wrapper. This makes it extremely hard to forge or duplicate as the person trying to copy the data matrix does not know all the data that is encoded on the data matrix. It is extremely difficult for a would-be forger or counterfeiter to be able to tell what data is encoded on the data matrix and whether there is further data beyond that which they can read. It is also extremely difficult for them to determine whether the data they can read is linked to an individual note or other data. Thus, the use of different layers of data encoded on, or reference by data encoded on the data matrix is highly advantageous as potential counterfeiters cannot be certain that further information is stored in a further layer whose existence cannot be determined.

Furthermore in the case where banknotes have been copied or counterfeited using a genuine banknote VBT identity, it is clear that since only one banknote can carry a genuine VBT identity, that if many banknotes were to be presented carrying the same identity, whether at the same or different locations, the authentication process and systems described would highlight, report and monitor that these other notes were in circulation and that all but one must be counterfeit. The hidden data held on the VBT or accessed by the authentication database could be used by a trusted or other authorised party to distinguish which of these notes was genuine.

The issuing party can hold the VBTs including alpha-numeric identifying numbers of physical notes, or the physical notes themselves with pre-issued data matrices before making the notes live when they are ready to release the notes into the market. The status of the note can then be changed in a central record of the note identifier to indicate that they are now live notes. Similarly, when notes are withdrawn for circulation, the status of the note can be changed to indicate that it is no longer live. The data matrix may include several layers of encryption. Many methods of encryption exist, and the type of encryption that is suitable in a given application is a question of choice for one skilled in the art

A cryptographic functions module is responsible for encryption of the data stored on the data matrix. Thus, the unique information that is printed on the data matrix is both stored in a central store and represented as encrypted data using proprietary algorithms to prevent the information printed on the data matrix being decrypted.

A secure key store includes a database and is the repository for the keys that are issued. Instead of a database, a hardware security module or other secure storage device could be used. Not all keys are placed on the data matrix but are issued to each party to the trusted relationship. The exact format will depend on the type of encryption used and whether or not it is symmetric or asymmetric.

The secure key store records those keys that have been use, or where appropriate, partially used. The secure key store can only be accessed through a secure management system and is protected by firewalls and backup systems. It is not actually necessary that the data matrix stores all the data relating to the bank note. The data matrix may merely store the public key for the encrypted data. This allows the bank note validator, who has a private key, to retrieve the data from the central store. The key gives access to that data only and may not give access to the information stored using different encryption keys in different levels of the data matrix. The key may give permission for the bank note data to be accessed once only or be accessed multiple times. This information can be retrieved or downloaded by a secure network such as a https internet connection.

At the receiver of a bank note, for example a retailer or a bank, the data matrix may be read to authenticate and validate the bank note. A data matrix reader may be used to read the notes and scan them. The notes may be validated locally or remotely depending on the degree of validation required. For example, local validation may simply read the basic layer of data, which may be the TIN, to confirm that the alpha-numeric code in the data matrix corresponds to that printed on the bank note. At a bank, the status of the bank note may be determined either on or off line. Once read, the bank note identifier may be compared to a list of note statuses. If this is done off line this will be a batched list updated on a regular basis. Alternatively, the comparison may be made on line with a list that is stored in the database that is updated in real time by the prime agencies involved.

The redeemed bank notes may be tracked and traced by a trusted third party and the status of notes checked at banks or trusted third party agencies.

The data matrixes for bank notes may be generated by the Bank of England, the central authority in the United Kingdom, or equivalent treasuries or responsible authorities in other countries. An agency server may hold data on notes which may include different currencies and denominations and be accessible by security authorities such as police, Interpol, Europol and other security services.

The audit and reporting elements of the core system described above are important to the bank note authentication system, as the system must be totally secure and offer non-repudiable identities and data relating to them. There are fundamental stages in the generation of the Banknote data and its subsequent authentication as follows:

(i) An ID generator producing the Banknote VBTs and issuing them to the Print Works.

(ii) A secure print works taking the data and then printing the banknotes. This could be done by batch or live depending on the data held in the payload of the VBT or in the data sets on the authentication server. If forensic data is required, such as time of printing, then it would have to be generated live. Otherwise, due to the speed and quantity of banknotes, printed batches are presently preferable.

(iii) The updating of the Banknote data repository; for example once notes have been printed, then again once they have been issued or released.

(iv) Administration interfaces and rules relating to the agency/s that holds the banknote data or runs the banknote authentication network. The rules define who has rights to amend the data or status of the banknotes or link reports to it.

(v) If many central banks (e.g. UK, Euro, Dollar) utilise the system it is unlikely that they will have full access to all the data about different countries' Banknotes, so making it more desirable that certain data linked to the individual identity of the banknotes will be published to an Authentication authority.

(vi) The points of presentation and what information can be retrieved at each point of presentation. Rules define the levels of drill down into the data held on the Authentication server or other agency systems and dictate the response to an authentication request. For a Web-based service secure identity verification is required

(vii) Token Lifecycle. A token is created for each bank note when or just before, the bank note is created and goes through a lifecycle that reflects the status of the banknote. Eventually, when the banknote is withdrawn from circulation the status of the banknote, which is held by the token will indicate that the note is no longer current. However, it may be desirable for the token still to be stored in the repository as a protection against fraud, for example, to prevent an attempt to use a withdrawn banknote.

(viii) Tracking & Tracing banknotes—the system may record where and when banknotes have been presented. This may be linked to the basic authentication and/or the person presenting the note. The banknote lifecycle may be viewed in terms of a clearing process, in which notes come back into a government banking system or the retail banking system and are sorted and authenticated before being redistributed.

The VBT can also be used on coinage with the VBT being applied by a known method such as laser etching. Although the low value of most coins would generally preclude coins, high value metal coins such as gold would warrant a VBT based security mark which is capable of being scanned.

The embodiment described will be further illustrated with reference to FIG. 13. The central authority for generating bank note identifiers is shown generally at 210. The central bank is responsible for the issue and withdrawal of bank notes and their identifiers. Information relating to the issue and withdrawal is communicated to security services such as Interpol and Europol shown at 220. Interpol is a multinational law enforcement agency which extends to over 180 countries. At the issuing authority or central bank a store is maintained of issued notes, notes that have been withdrawn and flagged notes. Flagged notes may include notes whose identifiers have been flagged to indicate that they are stolen or in some other way untrustworthy. The store is indicated at 222 in the figure.

The currency data which is encoded and encrypted into the data matrixes as discussed above is also stored at the issuing authority or a central bank as indicated by database 224 in the figure. The figure also shows examples of the issuing authorities such as the European Central Bank (ECB) 226 and the foreign treasuries which will have their own stores of bank note identifiers and currency data.

The data matrixes are generated at the secure print works 230 which prints bank notes. The ID creation and data matrix generation is shown generally at 232 and the cryptographic services at 234. Cryptographic services are used to encrypt data on the data matrix. The ID creation 232 is provided with the data that is to be encoded on the data matrix from the stores 222 and 224 at the identification authority. Once created, bank notes including the data matrix can be printed, as indicated at 236. When the notes are printed, but not issued, the status of the note in the issued note store will be “un-issued”. This status will be changed on issue of the note. Once notes have been released, they enter the banking system. Their release can be notified to security services such as Interpol as shown in the figure.

Information relating to the data stored in the bank notes store 222 at the issuing authority may also be mirrored by an ID authentication/status verification database 240. This database may be used by banks and retailers to check the authenticity of individual bank notes, via a secure https internet connection 242, when they are presented by customers. The authentication and status verification service may be provided by a trusted third party and the database 240 includes the issued notes store, flagged notes store and withdrawn notes store.

On presentation of a bank note, for example at a local bank branch, the note will be scanned with a data matrix scanner or machine reader 260 and information retrieved from the data matrix may either be verified locally or online via a secure internet https connection 242 to the authentication and status verification database 240. This will result in the bank note being accepted or rejected. In appropriate circumstances, information may be communicated to local security authorities such as police or other agencies indicated at 250. This may also be achieved through an https connection. The police or other authorities may also scan data matrices themselves, at 270, to authenticate and may be provided with access to the authentication and status verification database 240.

In the case, for example, of a robbery or the identification of counterfeit money, action may be taken locally to identify to remove stolen or counterfeit money. Action may be taken via an online secure connection to ensure that the notes are turned-off, that is their status in the stores 222 and 240 shows that they have been withdrawn. The notes may be trapped through points of presence and, on presentation, may be removed from circulation. This may be achieved by joint action between the bank branches and police authorities.

The user of a retail environment to check authenticity of bank notes is illustrated at 80. This use may be selective, in that it is enabled only at certain times, for example when there is a major threat of a terrorist attack or release of forged, or counterfeit, money into the system. The retail outlet may be linked to the authentication database 40 either directly or via the local bank server as illustrated in the figure.

It will be appreciated that the use of a VBT to carry data related to the bank note, or a reference to from where that data can be retrieved, can increase the security of a bank note. It is presently preferred that the VBT is used in addition to existing security techniques as described above. The may be created using one or more of these existing security measures and may even contain or reference some forensic data.

Thus the embodiments described have the advantage of producing bank notes and other security papers that can help combat counterfeiting and combat fraud, theft and money laundering.

The embodiment described enables a bank note or other security paper to be authenticated and for records of that authentication to be kept and reported to various authorities. When a bank note has been secured and authenticated, the authentication system may issue a receipt to the effect that the security papers has been authenticated. This receipt, itself, may carry a further VBT which may be related to the original VBT. For example, the new VBT may merely have a changed status indicator to show that the paper has been authenticated.

As the system is administered centrally, the status information that is read during authentication may be processed, using the audit and report functions described above, to generate reports at different levels depending on the status and permission of the receiving party, which may vary from a retailer receiving information regarding notes presented by them, to a central bank which will have access to, and receive much more detailed information.

It will be appreciated that the bank note can be authenticated at various points in its life cycle. Authentication points may include ATMs, cash sorters, bank telling machines and the like. These machines may have the ability to read the notes and via a link to the authentication system check their authenticity and status. Where the bank note is authenticated at a point such as an ATM, where the identity of the person using the machine is known, the identity of the bank note can be linked to the identity of an individual, or legal entity. Other authentication points may be used which are not part of a banking network, such as point of sale outlets which are already provided with scanners. It may be desirable for a mobile authenticator to be used which scans the note and communicates with the authentication system via a mobile communication telephony network. Such a system could be used by police or other authorities. Additionally, using existing mobile technology, it is possible for a consumer-based solution to be implemented allowing members of the public to use their mobile phones as banknote authenticators. As described elsewhere different authentication points may offer different levels of authentication and reporting to take place and these may be determined by role or privilege or some other access control. Mobile phone based authentication may use the camera that is incorporated into many modern cell phones to scan or form an image of the data matrix on the bank note. The data matrix can then be decoded by decoding software loaded onto the mobile phone. The data matrix can then be authenticated by sending the VBT to the system and receiving back authentication data by one of a number of possible techniques including SMS and MMS messaging and using networks such as GSM and 3GSM. In one preferred embodiment mobile internet connections based on GPRS (General Packet Radio Service) or WAP (Wireless Application Protocol) services may be used via an enabled mobile and its network service provider. In this respect it should be noted that the act of scanning the data matrix to form a digital image of it does not affect the integrity of the data in the VBT that is encoded onto the matrix.

In the embodiment described, reference has been made to the use of data matrixes and RFID tags have been given as an alternative. It will be appreciated by those skilled in the art that in some circumstances RFID tags may be used in addition to data matrixes.

The present invention has been described solely with reference to bank notes. It will also be appreciated that embodiments described may be applied to other forms of security paper including currency and notes. Other examples include bearer bonds, share certificates, travellers' cheques and postal orders. The invention is not limited to these examples and is applicable to any form of security paper which requires a security mark that can be registered or tracked at a high or low level.

1. A system for authentication of security papers comprising
a repository of security paper related data, the store including, for each of a plurality of security papers, a token including a unique identifier of a security paper, and a status indicator indicating the status of the security paper;
a generator for generating for a security paper a data carrier having encoded therein a token including a unique identifier from the store;
a scanner for scanning the encoded data carrier to retrieve the unique identifier from the token; and
an authenticator for comparing the unique identifier with stored identifiers and the status indicator corresponding to that unique identifier for authentication of the security paper, wherein the token comprises a header, a payload and a security portion, the payload comprising encrypted data relating to the security paper or a reference to a remote location at which that data is stored.

2. A system according to claim 1, wherein the unique identifier is carried in the header portion of the token.

3. A system according to claim 1, wherein the reference to a remote location carried in the payload is encrypted.

4. A system according to claim 1, wherein the data carrier is graphic symbol.

5. A system according to claim 4, wherein the graphic symbol is a data matrix.

6. A system according to claim 4, wherein the data carrier is an RFID tag.

7. A system according to claim 1, wherein the security paper is a banknote.

8. A system according to claim 1, wherein the authenticator is part of an authentication network comprising a plurality of authenticators, and the repository and the authenticators are linked.

9. A system according to claim 8, wherein at least one of the plurality of authenticators includes means for identifying an individual authenticator machine it operator and/or its location presenting a security paper for scanning, the system further comprising means for linking the record of the security paper stored at the repository to the individual.

10. A system according to claim 8, wherein the plurality of authenticators includes at least one mobile authenticator, comprising a mobile communications device, and a digital camera for forming an image of, or scanning, the data carrier on the security paper, the mobile communication device comprising software for decoding the token encoded on the data carrier.

11. A system according to claim 1, comprising means for issuing a receipt confirming that a security paper has been authenticated.

12. A system according to claim 11, wherein the receipt issuing means includes means for including on the receipt a token having a data content that is related to the data content of the token on the authenticated security paper.

13. A system according to claim 1, comprising an administrative and management interface to enable the status of a banknote to be updated and subsequently reported on to authorised parties.

14. A system according to claim 13, wherein all authentication attempts are reported through the administrative interface to enable authentications to be tracked.

15. A system according to claim 1, wherein the system gives the a party requesting authentication of a security paper access to further data relating to that security paper in accordance with identification criteria presented by the party requesting authentication to the system.

16. A security paper having a data carrier stored thereon, the data carrier having encoded thereon a token for authentication of the security paper using the system of claim 1.
